(19) United States
(12) Patent Application Publication
(10) Pub. No.: US 2017/0013861 A1
(43) Pub. Date: Jan. 19, 2017

(54) BIOLOGICAL FORMULATION FOR COMPLEMENTING AN ANIMAL FEED, PROCESS FOR OBTAINING A BIOLOGICAL FORMULATION FOR AN ANIMAL FEED AND AN ANIMAL FEED

(71) Applicant: PHB INDUSRIAL S.A., Serrana - SP (BR)

(72) Inventors: Roberto Vianna Nonato, Lapa, Sao Paulo (BR); Eduardo De Oliveira Brondi, Ribeirao Preto,Sao Paulo (BR); Sonia Maria Kesserlingh, Sao Paulo (BR)

(21) Appl. No.: 15/301,070

(22) PCT Filed: Apr. 1, 2015
(86) PCT No.: PCT/BR2015/050036

§ 371 Date: Sep. 30, 2016

(30) Foreign Application Priority Data
Apr. 1, 2014 (BR) BR1020140078720
Mar. 27, 2015 (BR) BR1020150069723

(51) Int. Cl. A23K 10/12; A23K 50/75; A23K 50/80

(52) U.S. Cl. CPC A23K 10/12; A23K 50/80; A23K 50/75

(57) ABSTRACT

The present invention refers to a biological formulation for complementing an animal feed, which comprises: dry cells of Cupriavidus necator or Alcaligenes latus bacteria, containing at minimum 40% of PHB and B vitamins, tyrosine, glutamic acid, phosphates and iron, which formulation may further contain the endogenous PHB depolymerase enzyme. The process for obtaining the formulation comprises the steps of: (a) producing, by aerobic fermentation, from 32 to 34° C., in a mineral and aqueous fermentative medium containing sucrose, glucose or other sugary streams derived from sugar production, cells of Cupriavidus necator or Alcaligenes latus bacteria containing at minimum 40% of PHB and B vitamins, tyrosine, glutamic acid, phosphates and iron; (b) inactivating the cells, thermally, at a temperature from 65 to 90° C. for 15 minutes; and (c) drying the bacteria cells obtained in the previous step.

### FIELD OF THE INVENTION

The present invention refers to a biological formulation comprising the fermentation of bacterial strains, such as Cupriavidus necator or Alcaligenes latus, to be applied for complementing animal feeds destined to both aquatic or terrestrial animals, such as farm animals, pets, with the objective to potentiate the weight gain and improve the health of the intestinal tract of said animals by modulating the micro flora thereof.

The synergistic action of the components of the formulation and the products from degradation of the PHA (polyhydroxyalkanoate), particularly of the PHB (poly-3-hydroxybutyrate), inherent to the fermentation of the strains mentioned above, results in a higher efficiency in the animal feed absorption, increasing the feed conversion rate and promoting a higher weight gain.

### BACKGROUND OF THE INVENTION

Antimicrobial agents (antibiotics and chemotherapeutics) have been used since the mid-twentieth century for improving the growth of animals by reducing the spread of diseases and by modulating the gut flora. The use of anti-microbial agents, in low doses, in animal feeds, may inhibit the bacterial metabolism and reduce the direct competition for the nutrients between the bacterium and the host, besides reducing the microbial production of metabolites, such as amines, ammonia and endotoxins which may have a direct effect on the intestinal epithelium and thus impede the absorption of nutrients.

In view of the possibility of inducing bacterial resistance and of the presence of residues in the milk and eggs, the public opinion has been forcing restrictions to the use of anti-microbial agents as growth promoters in several countries, with the European continent leading said prohibitions. Consequently, restrictions and new rules have arisen as to the use of antibiotics and chemotherapeutics as feed additives. Since 2006 the European Union has prohibited the use of any antimicrobial agent as growth promoter in animal products, but with the permission of using antibiotics and chemotherapeutics only for healing purposes. The pressure for removing the antimicrobial agents from the feeds has increased the search for alternative products which may guarantee the maximum growth of the animals, without affecting the quality of the end product.

Among said alternatives, short chain fatty acids have shown an optimum potential in the control and modulation of the gut flora, further exerting other important actions related to cellular homeostasis of the colonocytes (colon cells), such as anti-inflammatory, antioxidant and anti-carcinogenic activities.

Butyrate is among the three main short chain fatty acids (SCFA), formed in the interior of the colon, together with acetate and propionate. Although all the SCFA are important for the trophism of the colonocytes, the butyrate is the main one, since it is the largest energy producer for this type of cell and has an important regulatory function in relation to cellular proliferation and differentiation. It further has an important role in promoting water and sodium absorption and in the modulation of the intestinal flora.

A severe limitation in the use of butyrate in animal feeds, however, is related to its particularly unpleasant odor, reducing the feed attraction on part of the target animal, which may reject the feed. Besides this deleterious aspect, the free butyric acid (and its more common ionic forms: sodium butyrate and calcium butyrate) is rapidly absorbed in the upper digestive tract, reducing the availability in the more distal regions, where its action would be extremely desirable. Moreover, the butyrate is highly soluble in water, which limits the application thereof in feeds destined to aqueous animals, like fish and shrimps.

Several solutions have been proposed to overcome said problems and to potentiate the beneficial effects of the butyrate in animal nutrition. Among said solutions, one may point out the mixtures with several other products and the use of salts having less odor (Brazilian documents PI0707953-2, PI 0410980-5) or encapsulation of the active ingredient in systems of controlled release (EP2373181A1).

One way to overcome the problems related to the soluble forms of butyrate is the use of molecules having a higher molecular weight, such as glycerol esters (PI0520019-9) or insoluble polymeric chains, such as poly-hydroxyalkanoate (PHA) (US2010/0092422, US2010/0210726, WO99/34687). These several molecules present little or none disagreeable smell, do not significantly interfere in the flavor of the compound feed, and may even substitute thickeners and fatty components (WO 92/09211).

Particularly, some PHAs, such as PHB (poly-hydroxybutyrate) and PHB-HV (poly-hydroxybutyrate-co-hydroxyvalerate) are presented as an alternative which is highly interesting to the micro-encapsulated forms of butyrate, as they are highly thermally stable products of natural origin, (which can be applied in feed pelletizing processes) with no sign of toxicity. Since said components are insoluble and have a higher density than water, they are particularly adequate to feeds destined to benthonic aquatic animals (such as shrimp) or having bottom eating habits.

Both PHB and PHB-HV are also very stable in acid medium, and they are not degraded in the proximal digestive tract, making almost integrally its availability to the distal digestive tract: said components are degraded via enzymes solely by the gut micro flora and not by the digestive system of the target-animal.

The poly-hydroxyalkanoates (PHA), a family which includes the PHB and the PHB-HV, are polyesters naturally synthesized by a great number of living beings. With more than 170 different molecules described in literature, the commercial interest in the PHAs involves applications both in nutrition as in plastic industries, since they are polyesters with thermoplastic, natural and biodegradable properties. Several members of the PHA family have shown industrial application, the most representative being the PHB and PHB-HV, P4HB (poly-4-hydroxybutyrate), P3HB4HB (poly(3-hydroxybutyrate-co-4-hydroxybutyrate)) and some PHAmcl (poly-hydroxyalkanoates of average chain), the typical representative of said last family being the PHHx (poly-hydroxyhexanoate).

The chemical structure of the PHAs may be described as a polymeric chain, formed by repetitions of the following unit:

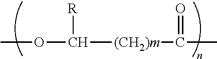

where R is an alkyl or alkenyl group of variable length and m and n are integers; in the polymers mentioned above, R and m assume the following values:
PHB: R=CH₃, m=1
PHB-V: R=CH₃ or CH₃—CH₂—, m=1
P4HB: R=H, m=2
P3HB-4HB: R=H or CH₃, m=1 or 2
PHHx: R=CH₃—CH₂—CH₂—, m=1

The great development of the natural sciences in the last two decades, particularly in biotechnology, has allowed the use of several different organisms, either natural or genetically modified, in the commercial production of PHAs. Particularly relevant to the present invention is the use of determined bacteria strains, capable of producing and accumulating, in the interior thereof, expressive amounts of said polymers. Cultured in specific conditions, which allow achieving high cell density, high content of intracellular polymer and yields compatible with the industrial process, said bacteria strains may use different renewable raw materials, such as sugar cane sugar, molasses or hydrolized cellulose extracts.

Particularly when applied to animal nutrition, one should use bacterial strains with low or no pathogenic potential or low or no production of harmful substances to the target animal. In this sense, it is found an excellent application potential in bacterial strains of the species Alcaligenes latus and Alcaligenes eutrophus (the latter also receiving the names Waltersia eutropha, Ralstonia eutropha, currently Cupriavidus necator). Cupriavidus necator has been described in literature as being potentially applicable as a unicellular protein source. The substitution of up to 45% of the protein source in chicken feeds by dry cells of Cupriavidus necator, has not resulted in any deleterious effect to the target animals, indicating high safety of said bacterial strain (H. A. Greife et al., “Nitrogen metabolism in broiler chickens consuming the bacterial strain Alcaligenes eutrophus”, Animal Feed Science and Technology Volume 5, Issue 3, Pages 241-253, September 1980).

When the PHB (and in a similar way, the PHB-HV) is included in the feed, it passes through the proximal digestive tract practically without suffering any alteration. Upon reaching the regions of higher activity of the intestinal micro flora, the enzymes produced by said microorganisms break the polymeric chain, releasing units of 3-hydroxybutyrate (and also 3-hydroxyvalerate, in the case of PHB-HV). It is interesting to note that the 3-hydroxybutyrate is one of the known ketone bodies, which are compounds produced in the catabolism of fatty acids. These compounds have a crucial importance as energy source in conditions of low availability of carbohydrates, since they may be used by a great variety of the animal's cells, including the nervous system, heart and muscle tissue. By the way, both the heart and the renal cortex are structures which prefer the ketone bodies rather than glucose.

Particularly, the 3-hydroxybutyrate has several metabolic effects, functioning as a signaling means in a series of cycles and reactions which have not been totally elucidated. Apparently, the 3-hydroxybutyrate has an effect of improving the mitochondrial respiration, increasing the production of ATP and reducing the cellular oxidative stress.

Nevertheless, since the PHB (or the PHB-HV) depends on the intestinal flora to release the active ingredient 3-hydroxybutyrate, several factors will influence this release, as the time in which it remains in the animal's gut, the association with substances that promote the release, the shape of the PHB particles (and the consequent bio-availability of the product to the attack of the gut bacterial flora), and the composition of the micro flora itself.

Document U.S. Pat. No. 8,603,518 discloses a formulation directed to animal feeds having PHB and bacterial strains capable of breaking its polymeric chain, or purified enzymes having a similar effect, such as PHB depolymerase. However, said solution presents a disadvantage, since the contact of the PHB with the enzyme, before it is administered to the animal, may start the rupture of the chain in a premature way, releasing the active ingredient 3-hydroxybutyrate much before it can reach the distal portions of the digestive tract of the target animal. This effect reduces the advantages of the PHB when compared to the more common forms of administering the (sodium or calcium butyrate, micro-encapsulated).

Formulations involving the simultaneous use of PHB with bacterial strains capable of breaking its polymeric chain, which corresponds to the other possibility presented in the same document, face similar problems, since these strains may start the degradation of the polymeric chain of the PHB prematurely. Moreover, the use of live bacteria in feed formulations is more complicated, as it makes impossible the pelletization (high temperature). Thus, the PHB/bacteria composition needs to be administered separately from the feed, or the feed must be only formulated just before it is used.

### SUMMARY OF THE INVENTION

In view of the facts commented above and directed to the difficulties and drawbacks regarding the use of the PHB in the composition of different types of animal feed, the present invention has the objective of minimizing or even eliminating the disadvantages found up to now in the efficient and economically viable use of PHB in the composition of animal feeds, aiming at potentializing the weight gain and improving the health of the in the intestinal tract. The present invention resulted from a careful study about the best form of offering PHB to the target animal, which resulted in a novel biological formulation capable to be used for complementing the animal feed is several applications.

According to one aspect of the invention, it is provided a biological formulation which comprises: dry cells of Cupriavidus necator or Alcaligenes latus bacteria containing at minimum 40% of PHB and B vitamins, tyrosine, glutamic acid, phosphates and iron, and which may also contain high levels of endogenous PHB depolymerase.

The invention further refers to a process for obtaining a biological formulation as mentioned above, which process comprises the steps of: producing, by aerobic fermentation, in a mineral and aqueous fermentative medium containing sucrose, glucose or other sugary streams derived from sugar production, cells of Cupriavidus necator or Alcaligenes latus bacteria containing at minimum 40% of PHB and B vitamins, tyrosine, glutamic acid, phosphates and iron; and drying the bacteria cells obtained in the previous step.

The invention allows obtaining animal feeds containing the present formulation, potentializing the weight gain and improving the health of the intestinal tract of the animals nourished with said feed.

### DESCRIPTION OF THE INVENTION

A significant aspect of the present invention is due to fact that the use of cells of the bacteria Alcaligenes latus or Cupriavidus necator, containing at least 40% of intracellular PHB, presents an effect much more accentuated in terms of weight gain of the target animal than the application of purified PHB, on the same bases of active ingredient content. Possibly, the bio-availability of the PHB to the micro flora of the intestinal tract is greater when still associated with the cellular content of the producing bacterium, as compared to the forms of commercially available purified PHB. The associated cellular components may further present a synergistic effect to the 3-hydroxybutyrate released as, for example, B vitamins, in particular vitamin B2 and the amino acid Tyrosine, which are present in expressive quantities in the present strain cells. B vitamins and tyrosine are connected to the degradation cycle of fatty acids and formation of ketone bodies, which metabolically approach them to the hydroxybutyrate.

A second inventive aspect of the present formulation refers to the endogenous and controlled production of the enzyme (PHB depolymerase) responsible for the PHB degradation by the PHB producing strains employed. This enzyme has a fundamental role for the survival of the Cupriavidus necator or Alcaligenes latus in conditions of restriction of carbon (energy) sources, being responsible for the mobilization of the intracellular PHB, accumulated upon abundance conditions.

The PHB depolymerase produced by said bacterial strains has an activity profile as a function of the pH extremely interesting for the applications in animal nutrition, since it acts effectively at a pH from 6 to 8, but is inactive in a pH below 5. Considering the digestive tract of the farm animals in general, the pH of the proximal portion (stomach) is about from 3.5 to 4.0, in which condition the depolymerase is not active. Proceeding in the digestive tract, the pH increases gradually, reaching about 6.5 in the more distal portions (caecum and colon). This means that the highest effect of said enzyme will occur precisely in the region in which exists the major interest for its actuation.

Through a series of fermentation assays, the technicians tried to understand in which situations the PHB producing strains presented the higher activity of depolymerase, without significantly affecting the own production of PHB. They verified that the cell culture in situations of higher temperatures, from 36 to 40° C., corresponds to the maximum production of depolymerase, about 5 times more than the cells cultured in optimum conditions of PHB production, which occurs in the interval of 32-34° C. In this situation of higher temperature, the polymeric chains formed are smaller than those obtained by fermentation from to 34° C. (800.000 Da, versus 1.000.000 Da), with the increase in the consumption of the carbon source (from 5% to 20%).

Thus, by cultivating the PHB producing strains Alcaligenes latus or Cupriavidus necator at temperatures from to 40° C., cells are obtained with high content of depolymerase, PHB content from 40 to 80% of the dry cellular weight and molecular weight in the range of 800.000 Da. The nutritional effect of applying the dry cellular material in animal feeds, occurs mainly in relation to weight gain and alimentary conversion, being notably more accentuated in the cases in which the cited pH conditions are present, such as in chicken and swine.

However, a higher content of active endogenous PHB depolymerase tends to degrade the intracellular PHB prematurely, reducing the period of validity of the material to be used in feeds. In order to avoid said premature degradation of the PHB chains, the produced biomass receives, before the drying step, from 0.1 to 0.5 g/L of an acidifying agent, such as citric acid, lactic or propionic acid, which stops the action of the depolymerase during storage, but which will not impede is activity when ingested by the target animal.

Another aspect involved in the present invention refers to the specificity of the formulations, as a function of the characteristics of the animal which will receive the PHB-based nutritional complement. For the animals in which the intestinal residence time is very short as, for example, shrimps, the assignees developed a simple process for the partial rupture of the polymeric chains of the PHB, in order to deliver to the animal a smaller molecule, which is more rapidly processed by the micro flora, however still insoluble in water, odorless and sufficiently thermo-stable, so as to allow pelletizing the feed.

The production of said formulation is based on the partial rupture of the polymeric chains of the intracellular PHB. This process comprises collecting the cells of said strains, preferably immediately after the process of fermentation and treatment with alkalis, under temperatures from 70 to 90° C. The authors found out that, if the treatment with alkali is effected in up to twelve hours after the final of the fermentative process, the cells are completely hydrolyzed at pH values from 8 to 12 and at room temperature, which does not occur with the cells stored for a longer time after fermentation, or with dry cells. In order to break the cells stored for a time superior to twelve hours after the end of the fermentative process, or with dry cells re-suspended in water, the authors found out that is necessary to raise the pH of the medium to values superior to 12, in this case existing the possibility of destruction of the important nutritional elements present in the cell and significant increase of concentration of salts in the formulations.

Upon heating the suspension, containing cells collected up to twelve hours after the fermentative process and from 70 to 90° C., at a pH from 8 to 12, it occurs a practically instantaneous cell rupture. Maintaining these conditions for one hour, the polymeric chains of the PHB are broken from about 1.000.000 (original molecular weight of the intracellular PHB) to values inferior to 100.000 Da. After this period of time, the medium is neutralized with acid at a pH from 6 to 8 and the material is dried.

Different feed were prepared, comprising:

1. Commercial purified PHB (sold with the trademark “Biocycle 1000®”);
2. Gross dried cells of Alcaligenes latus or Cupriavidus necator, containing from 40 to 80% of PHB by weight;
3. Gross cells of Alcaligenes latus or Cupriavidus necator, containing from 40 to 80% by weight of PHB, cultured in temperature conditions from 36 to 40° C., favoring a greater production of PHB depolymerase, added with from 0.1 to 0.5 g/L of citric or propionic acid after submitted to fermentation and dried.
4. Gross cells of Alcaligenes latus or Cupriavidus necator ruptured at a pH from 8 to 12, with posterior neutralization with acid at a pH from 6 to 8 and dried;
5. Gross cells of Alcaligenes latus or Cupriavidus necator ruptured with alkali at a pH from 8 to 12, heated at temperatures from 70 to 90° C. during 1 hour, with posterior neutralization with acid at a pH from 6 to 8 and dried;

These feed compositions were offered to different farm animals, with distinct results being observed.

The following examples show some of the procedures adopted in the production of the formulations 1 to 3, without constituting a limitation for the possible applications in relation to the ones exposed herein.

### EXAMPLES

### Example 1

### Formulation 2—Production of Cells of the Present Bacterial Strains, Containing from 40 to 80% of Intracellular PHB

A fermenter vessel under agitation, capable of controlling the temperature of the medium under fermentation and of supplying oxygen to the process micro-organism in an amount sufficient to allow the rapid growth thereof, receives a sterile inorganic aqueous culture medium comprising macro nutrients (nitrogen, phosphate, magnesium) and micro nutrients (zinc, nickel, cobalt, molybdenum, iron, copper, boron) in sterile conditions. This fermenter is inoculated with active cells, for an initial cellular concentration not inferior to 1 g/L in a dry basis. The cellular multiplication occurs with the controlled continuous addition of a carbon source, essentially glucose syrup, sucrose syrup, molasses or other streams containing sucrose, derived from a sugar factory. The temperature and pH are maintained constant at 32-34° C. and 6.5, respectively, using ammonia, both for pH control and to give the cells a nitrogen source. After reaching a cellular concentration of about 100 g/L in dry basis, the ammonia supply is cut, interrupting the cellular multiplication. Maintaining the addition of the carbon source, the bacterial cells, impeded to multiply, accumulate PHB, until they are thermally inactivated to a temperature from 65 to 90° C. during 15 minutes. Following this protocol, it was possible to produce cells with optimum efficiency, achieving a content of intracellular PHB in the order of 80% of the dry cellular weight, with average molecular weight of about 1.000.000 Da. Upon reaching this content of PHB, the cells are pasteurized at 85° C. for 15 minutes and dried in a spray type drier. The product obtained from the drying may be used directly in the feed formulation. Cells produced as described in this example has an average composition presented in the following table:

| Component | Final dry material content |
|---|---|
| Humidity | <5% |
| Ashes | <2% |
| Total lipids | >2% |
| Total carbohydrates | >60% |
| Total protein | >20% |
| Vitamin B1 | >10 ppm |
| Vitamin B2 | >100 ppm |
| Vitamin B3 | >05 ppm |
| Iron | >70 ppm |
| Phosphor | >0.4% |
| Tyrosine | >0.3% |
| Alanine | >200 ppm |
| Glutamic acid | >400 ppm |

### Example 2

### Formulation 3—Production of the Present Bacterial Strain Cells, Containing from 40 to 80% of Intracellular PHB with High Depolymerase

A fermenter vessel under agitation, capable of controlling the temperature of the medium under fermentation and of supplying oxygen to the process micro-organism in an amount sufficient to allow the rapid growth thereof, receives a sterile inorganic aqueous culture medium comprising macro nutrients (nitrogen, phosphate, magnesium) and micro nutrients (zinc, nickel, cobalt, molybdenum, iron, copper, boron) in sterile conditions. This fermenter is inoculated with active cells, for an initial cellular concentration not inferior to 1 g/L in a dry basis. The cellular multiplication occurs with the controlled continuous addition of a carbon source, essentially glucose syrup, sucrose syrup, molasses or other streams containing sucrose, derived from a sugar factory. The temperature and pH are maintained constant from 36 to 40° C. and 6.5, respectively, using ammonia, both for pH control and to give the cells a nitrogen source. Upon reaching a cellular concentration of about 100 g/L in dry basis, the ammonia supply is cut, interrupting the cellular multiplication. Maintaining the addition of the carbon source, the bacterial cells, impeded to multiply, accumulate PHB.

Following this protocol, it was possible to produce cells with optimum efficiency, achieving a content of intracellular PHB in the order of 80% of the dry cellular weight.

Upon reaching this PHB content, the cells receive from 0.1 to 0.5 g/L of citric or propionic acid and are dried in a spray type drier, without being submitted to a pasteurization step, avoiding loss of enzymatic activity. The product obtained from the drying may be directly used in the feed formulation.

Cells produced as described in this example have an average composition very similar to that described in example 1, however containing about 5 times more polymerase, with the polymeric chains of the PHB being formed of about 800.000 Da.

### Example 3

### Formulation 4: Gross Cells of Alcaligenes latus or Cupriavidus necator Ruptured at pH from 8 to 12, with Posterior Neutralization with Phosphoric Acid at pH from 6 to 8 and Dried

Cells of Alcaligenes latus or Cupriavidus necator, produced as described in example 1, preferably not more than twelve hours after the end of the fermentative step, before the drying step are added with a solution of ammonium hydroxide, increasing pH up to values from 8 to 12, under agitation. In these conditions, it occurs in a few minutes the complete rupture of the cellular wall. After fifteen minutes under agitation, this solution is neutralized with the addition of phosphoric acid up to a pH from 6.0 to 8.0 and sent to a spray type drier. The product obtained from the drying step (formulation) presents the dry cells with a pH from 6 to 8 and may be applied directly in the feed composition.

### Example 4

### Formulation 5: Gross Cells of Alcaligenes latus or Cupriavidus necator Ruptured at pH from 8 to 12, Heated to Temperatures from 70 to 90° C. During One Hour, with Posterior Neutralization at a pH from 6 to 8 with Phosphoric Acid and Dried

Cells of these strains, containing the Intracellular PHB in a content of about 80% of the dry cellular weight, produced as described in example 1, preferably collected no more than twelve hours after the final fermentative step, before the drying step, receive the addition of a solution of ammonium hydroxide, increasing the pH up to values from 8 to 12, under agitation. In these conditions, it occurs in a few minutes the complete rupture of the cellular wall. This solution is then heated to a temperature from 70 to 90° C. and remains under agitation for a period of 1 hour. In this example, the molecular weight was reduced from 1.000.000 Daltons to values inferior to 100.000 Daltons. After this period under agitation, the solution is neutralized with the addition of phosphoric acid up to a pH from 6 to 8 and sent to a spray type drier. The product obtained from the drying step (formulation) presents the dry cells with a pH from 6 to 8, and it may be applied directly in the feed composition.

The formulations prepared above were offered to different farm animals, with different distinct results being observed, as described in the examples of application below, without constituting a limit to the possible applications of the ideas exposed herein by the authors:

### Example 5

### Application of the Formulations 1 to 3 in the Feed Composition for Broiler Chickens, During the Initial Growing Cycle, from 1 to 21 Days

For this study it was used 336 chickens, males of Cobb lineage 500, received with one day of life. The chickens were housed in 28 cages, with 12 chickens being in each experimental unit. These chickens were submitted to 7 different treatments, each with 4 repetitions, distributed randomly in 7 blocks of 4 experimental units, with two daily observations being made, in order to evaluate the general conditions of the batch, such as temperature, illumination, water, feed and conditions of the bed of each one of the boxes.

The treatments of each batch of chickens were based on a pattern feed. Using this basal feed, the different treatments were developed as follows:

| | | chicken/ | chicken/ |
|---|---|---|---|
| | Treatments | cage | Treat. |
| T1 | Basal feed - No addition of any product | 12 | 48 |
| | (negative control) | | |
| T2 | Basal feed - with addition of sodium | 12 | 48 |
| | butyrate 30% (positive control) | | |
| T3 | Basal feed - with Commercial purified | 12 | 48 |
| | PHB (Biocycle ®) - same dosage of the | | |
| | sodium butyrate 30% | | |
| T4 | Basal feed - with dry cells (formulation | 12 | 48 |
| | 1) in the same dosage of the sodium | | |
| | butyrate 30% | | |
| T5 | Basal feed - with dry cells (formulation | 12 | 48 |
| | 2) in the same dosage of the sodium | | |
| | butyrate 30% | | |
| T6 | Basal feed - with ruptured dry cells | 12 | 48 |
| | (form.2) in the same dosage of the | | |
| | sodium butyrate 30% | | |
| T7 | Basal feed - with ruptured dry cells | 12 | 48 |
| | with PHB of low molecular weight | | |
| | (formulation 3) in the same dosage of | | |
| | the sodium butyrate 30% | | |

The quantity of formulation applied in the feeds presented as reference the used quantity of butyrates/feed ton, that is, within the interval from 200 g/feed ton to 1.000 g/feed ton.

The results obtained with these different treatments are related in the Table—Average weight, average weight gain, average feed consumption, alimentary conversion and mortality during the experimental period from 0 to 21 days:

| | | | | | Average | |
|---|---|---|---|---|---|---|
| | Accumu- | Average weight (PM) | | | feed | |
| | lated | and average weight | | | Consump- | Alimen- |
| Treat- | mortality | Gain(GPM)/chicken (g) | | | tion | tary con- |
| ment | % | PM 0 | PM 21 | GPM | (g) | version |
| T1 | 2.08 | 0.093 | 0.968 | 0.875 | 1.257 | 1.435 |
| T2 | 10.41 | 0.094 | 1.018 | 0.923 | 1.278 | 1.371 |
| T3 | 4.16 | 0.095 | 0.990 | 0.895 | 1.224 | 1.361 |
| T4 | 8.33 | 0.093 | 1.033 | 0.939 | 1.274 | 1.354 |
| T5 | 6.55 | 0.095 | 1.037 | 0.942 | 1.278 | 1.351 |
| T6 | 2.08 | 0.092 | 0.959 | 0.866 | 1.220 | 1.407 |
| T7 | 4.16 | 0.093 | 0.974 | 0.881 | 1.213 | 1.361 |
| P. Value | 0.18 | 0.78 | 0.08 | 0.08 | 0.44 | 0.08 |
| C.V. % | 97.85 | 2.72 | 3.84 | 4.20 | 4.64 | 3.08 |
| R2 | 0.32 | 0.11 | 0.39 | 0.39 | 0.21 | 0.39 |

The results shown in this example indicate that, for broiler chickens in the initial growth period, the addition of dry gross cells containing at least 40% of PHB, produced as described in example 2 (T5), has an accentuated effect in the increase of the animal's weight gain, improving the alimentary conversion rate. This type of nutritional complementation has an effect more accentuated than those verified for sodium butyrate or Purified PHB.

### Example 6

### Application of the Formulations 2 to 4 in the Feed Composition for Broiler Chickens, During the Whole Productive Cycle, from 1 to 42 Days

For this study there were used 2.352 chickens, males of the Cobb lineage 500, received with one day of life. The chickens were housed in 42 boxes, with 56 chickens being in each experimental unit. These chickens were submitted to different treatments, distributed randomly in 06 blocks of 07 experimental units, with two daily observations being made, in order to evaluate the general conditions of the batch, such as temperature, illumination, water, feed and conditions of the bed of each one of the boxes.

The treatments of each chicken batch were based on a pattern feed, with the following composition:

From this basal feed, the different treatments were developed as follows:

| | Treatments | chickens/box | chickens/Treat. |
|---|---|---|---|
| T1 A | Basal feed - no addition of | 56 | 448 |
| | any product | | |
| | (negative control) - | | |
| T2 B | Basal feed - with addition | 56 | 448 |
| | of sodium butyrate 30% | | |
| T3 C | Basal feed with addition of | 56 | 448 |
| | calcium butyrate 45% | | |
| T4 D | Basal feed with dry cells | 56 | 448 |
| | produced as described in | | |
| | Ex. 2 - formulation 2. | | |
| T5 E | Basal feed with ruptured | 56 | 448 |
| | dry cells produced as | | |
| | described in Ex. 3 - | | |
| | formulation 3. | | |

The results obtained with these different treatments are shown in the Table—Average weight, average weight gain, average feed consumption, alimentary conversion and mortality during the experimental period from 0 to 42 days:

| | | | Average weight(PM) | | | Feed | | |
|---|---|---|---|---|---|---|---|---|
| | chicken | | and average weight | | | consump- | Alimen- | |
| Treat- | per | % | gain (GPM)/chicken, (kg) | | | tion | tary con- | GPD |
| ments | treatment | death | PM | PM2 | GPM | (kg) | version | (g/day) |
| T! - basal | 448 | 6.70 | 44.51 | 2.686 c | 2.642 c | 5.084 | 1.833 | 63.9 c |
| T2 - Na, | 448 | 6.47 | 44.77 | 2.753 abc | 2.709 abc | 5.058 | 1.789 | 65.5 a |
| butyrate 30% | | | | | | | | |
| T3 - Ca, | 448 | 4.91 | 44.53 | 2.699 c | 2.655 bc | 5.116 | 1.874 | 64.3 b |
| butyrate 45% | | | | | | | | |
| T4 - dry cells | 448 | 5.58 | 44.80 | 2.770 ab | 2.726 ab | 5.222 | 1.848 | 65.9 a |
| T5 - dry and | 448 | 6.63 | 44.87 | 2.795 a | 2.750 a | 5.124 | 1.798 | 66.5 a |
| ruptured cells | | | | | | | | |
| P. value | — | 0.8406 | 0.5468 | 0.0148 | 0.0157 | 0.5410 | 0.1825 | 0.01 |
| C.V. % | — | 55.17 | 1.13 | 2.34 | 2.38 | 4.23 | 3.72 | 2.38 |
| R² | — | 0.31 | 0.36 | 0.39 | 0.39 | 0.30 | 0.32 | 0.39 |

Averages with distinct letters differ statistically by DUNCAN test in 5% of probability

The results shown in this example indicate that, for broiler chickens, during the whole production cycle, from to 42 days, the addition of ruptured dry cells (T5) containing at least 40% of PHB, produced as described in example 2, has an accentuated effect in the increase of the animal's weight gain, improving the alimentary conversion rate. This type of nutritional complementation has an effect more accentuated than those verified for sodium butyrate (T2), calcium butyrate (T3) or dry gross cells (T4).

### Example 7

### Utilization of Feeds Containing the PHB, Under Different Forms, in Marine Shrimps, During the Entire Productive Cycle, from 1 to 72 Days

This study aimed at evaluating the zoo-technical performance of white juvenile shrimps, Litopenaeus vannamei, fed with eight treatments. The research focused in categorizing the different additives, from the zoo-technical point of view (survival, alimentary conversion factor, growth, body weight and productivity), using 1.280 shrimps, divided among a total of 32 tanks which operate with clear water, in a continuous recirculation and filtration regime. Four repetitions were adopted (i.e., four culture tanks) for each experimental treatment. A totally casual procedure was used in the work.

The treatments of each batch of shrimps were based on a pattern feed. From this basal feed, the different treatments were developed as follows:

| | Identification | | shrimps/ | shrimps/ |
|---|---|---|---|---|
| | Treatment | Treatments | tank | treatment |
| T1 | CLT | Basal feed - No addition | 40 | 160 |
| | | of any product (negative | | |
| | | control) | | |
| T2 | BUS | Basal feed - with addition | 40 | 160 |
| | | of sodium butyrate 30% | | |
| | | (positive control) | | |
| T3 | BUC | Basal feed - with addition | 40 | 160 |
| | | of calcium butyrate 45% | | |
| | | (positive control) | | |
| T4 | BIO | Basal feed - with | 40 | 160 |
| | | Commercial purified PHB | | |
| | | (Biocycle ®) - same dosage | | |
| | | of the butyrate de 30% | | |
| T5 | FS1 | Basal feed - with dry | 40 | 160 |
| | | cells (formulation 1) in | | |
| | | the same dosage of the | | |
| | | sodium butyrate 30% | | |
| T6 | FS2 | Basal feed - with dry | 40 | 160 |
| | | cells (formulation 1) | | |
| | | inferior to the sodium | | |
| | | butyrate 30% | | |
| T7 | FSH | Basal feed - com ruptured | 40 | 160 |
| | | dry cells (formulation 2) | | |
| | | in the same dosage do | | |
| | | sodium butyrate 30% | | |
| T8 | FSB | Basal feed - with ruptured | 40 | 160 |
| | | dry cells of low molecular | | |
| | | weight (formulation 3) in | | |
| | | the same dosage of the | | |
| | | sodium butyrate 30% | | |

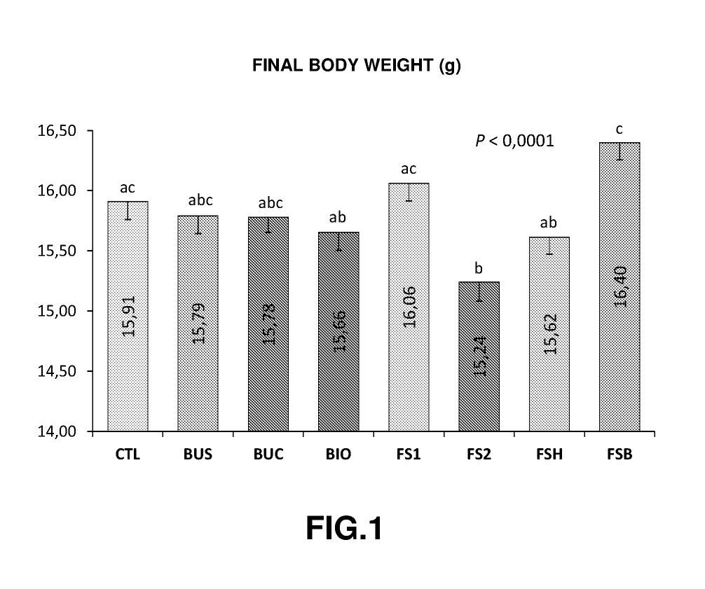

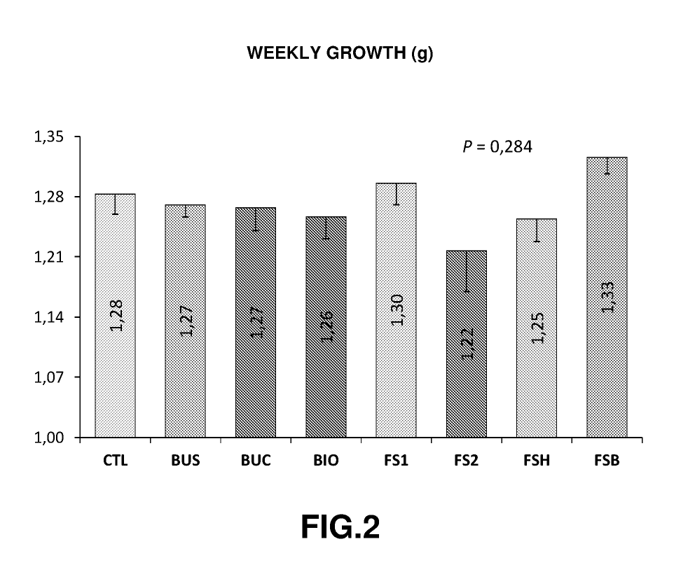

At the end of the experimental period of 72 days, it was found that the shrimp L. vannamei presented an average weight gain of 13.3 g during the whole experimental period, shown in FIG. 1 of the appended drawings. This corresponds to an average weekly growth of 1.3 g (FIG. 2 of the appended drawings), considered superior to what is aimed as a desirable goal shrimp commercial farms (i.e., 1.0 g/week).

A statistical difference was noted in the final body weight of the shrimps as a function of the diet. The shrimps fed with the FSB diet presented a higher body weight as compared with those fed with the other diets. Diet FSB resulted in an additional body weight gain of 0.48 (3.0%), 0.61 (3.8%) and 0.61 (3.9%) g, respectively, in relation to the shrimps fed with the diets CTL, BUS and BUC. Thus, there was a tendency to increase the body weight in the L. vannamei upon using the additive FSH in the inclusion of 0.50%.

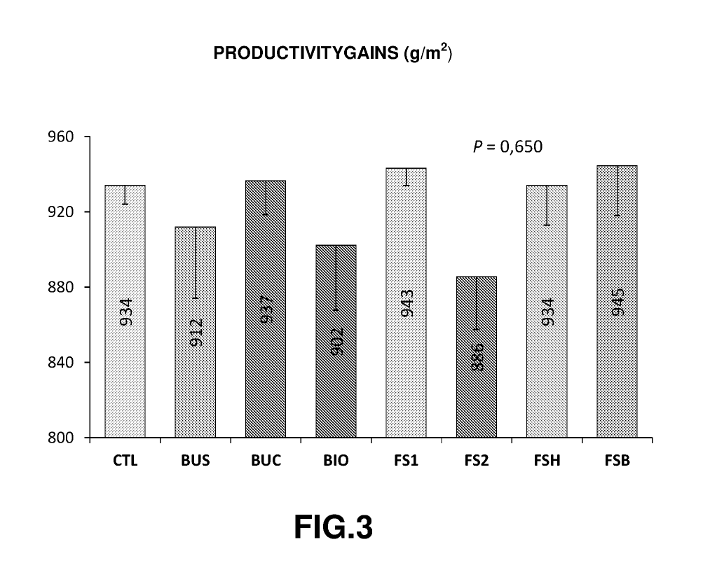

The productivity gain, a zoo-technical parameter which reflects the final survival of the shrimps and the acquired body weight, presented a differentiated behavior among the diets. There was a clear tendency to higher absolute values when the shrimps were fed with the FS1 and FSB diets. The shrimps fed with the FS1 and FSB diets reached a higher productivity gain (FIG. 3 of the appended drawings) of 25.9 (2.8%) and 27.1 g/m² g (3.0%) as compared with the average obtained with the other treatments (i.e., 917.4 g/m²).

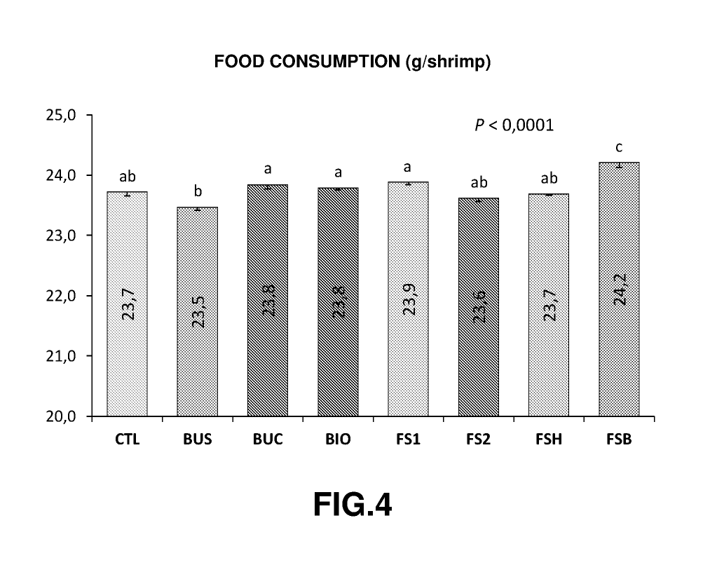

The same treatments promoted a higher feed consumption (FIG. 4 of the appended drawings), showing the preference of the shrimps for the feeds containing the FS1 and FSB additives, that is, an increase in the feed palatability.

1. A biological formulation, for complementing an animal feed, it which comprises dry cells of Cupriavidus necator or Alcaligenes latus bacteria, vitamins, tyrosine, glutamic acid, phosphates and iron.

2. The biological formulation, according to claim 1, further comprising endogenous PHB depolymerase enzyme.

3. The biological formulation, according to claim 1, comprising ruptured dry cells.

4. The biological formulation, according to claim 3 wherein the ruptured dry cells present a PHB with a molecular weight less than 100.000 Da.

5. The biological formulation, according to claim 3, characterized in that the dry cells present a pH from 6 and 8.

6. A process for obtaining a biological formulation for an animal feed, which comprises the steps of:
a—producing, by aerobic fermentation, from 32 to 34° C., in a mineral and aqueous fermentative medium, containing sucrose, glucose or other sugary streams derived from sugar production, cells of Cupriavidus necator or Alcaligenes latus bacteria containing at minimum 40% PHB and B vitamins, tyrosine, glutamic acid, phosphates and iron.
b—inactivating the cells, thermally, at a temperature from 65 to 90° C. for 15 minutes; and
c—drying the bacteria cells obtained in the previous step.

7. The process, according to claim 6, characterized in that it further comprises, before the step of drying the Cupriavidus necator or Alcaligenes latus cells, the step of rupturing said cells by increasing the pH of the fermentative medium to values from 8 and 12 during at maximum 15 minutes by adding alkali and then neutralizing up to a pH from 6 and 8 by the addition of acid, in a period not superior to twelve hours after the end of the fermentative process.

8. The process, according to claim 7, further comprising, before the step of neutralizing with acid, the step of heating the ruptured cells to a temperature from 70 to 90° C. for 1 hour, provoking the reduction of the molecular weight of the PHB up to values lower than 100.000 Da.

9. A process for obtaining a biological formulation for an animal feed, comprising the steps of:
a—producing, by aerobic fermentation, from 36 to 40° C., in a mineral and aqueous fermentative medium, containing sucrose, glucose or other sugary streams derived from sugar production, cells of Cupriavidus necator or Alcaligenes latus bacteria containing at minimum 40% PHB, B vitamins, tyrosine, glutamic acid, phosphates, iron and the endogenous PHB depolymerase enzyme;
b—adding, to the fermented material, citric acid, propionic acid or lactic acid, or a mixture thereof, to a total final concentration from 0.1 and 0.5 g/L;
c—drying the bacteria cells obtained in the previous step.

10. (canceled)

11. An animal feed, which comprises from 0.1 and 5% by weight of a biological formulation comprising: dry cells of Cupriavidus necator or Alcaligenes latus bacteria, containing at minimum 40% of PHB and B vitamins, tyrosine, glutamic acid, phosphates and iron.

12-15. (canceled)
